(19) United States
(12) Patent Application Publication
(10) Pub. No.: US 2020/0019940 A1
(43) Pub. Date: Jan. 16, 2020

(54) Method of Managing Pre-Dedicated Funds

(71) Applicant: Cesar Torres, Woodland, CA (US)

(72) Inventor: Cesar Torres, Woodland, CA (US)

(21) Appl. No.: 16/510,832

(22) Filed: Jul. 12, 2019

Related U.S. Application Data
(60) Provisional application No. 62/697,237, filed on Jul. 12, 2018.

(51) Int. Cl. G06Q 20/10; G06Q 30/02

(52) U.S. Cl. CPC G06Q 20/10; G06Q 30/0215

(57) ABSTRACT

A method of managing pre-dedicated funds allows the user to purchase, distribute, and manage gift cards. The method allows companies to provide discounts and promotions to gift card users. A plurality of user accounts is managed by at least one remote server, wherein each user account is associated with a corresponding user personal computer (PC) device. The plurality of user accounts allows each user of the present invention to interact with each other through the at least one remote server in order to manage gift cards. The at least one remote server accepts wireless electronic inputs and returns appropriate electronic outputs. The corresponding PC device is any computer, laptop, smartphone, or other such internet-enabled device that allows the plurality of users to connect to the at least one remote server. This arrangement enables each user to interact with the at least one remote server using the corresponding PC device.

The current application claims a priority to the U.S. Provisional Patent application Ser. No. 62/697,237 filed on Jul. 12, 2018.

### FIELD OF THE INVENTION

The present invention generally relates to gift cards and business/marketing strategies. More specifically, a method of managing pre-dedicated funds relates to improved systems and methods for facilitating the creation of gift cards by businesses. Such a method encourages users to purchase and spend the gift cards.

### BACKGROUND OF THE INVENTION

The creation of the gift card provides an excellent incentive for consumers to make purchases at various storefronts. In general, gift cards are prepaid stored-value currency cards issued by businesses as alternatives to traditional payment methods for financial transactions within a particular business or associated businesses. The purchaser of the gift card can demonstrate their knowledge of a gift receiver through their choice of gift card location. The receiver then is incentivized to utilize the gift card to its full value, which typically results in spending slightly more money than the prepaid value. Thus, the store benefits from the initial purchase and often the follow-up purchase from the user. Traditionally, gift cards are issued as physical cards with value stored in them, allowing users to carry the gift cards around and use them similar to how credit/debit cards would be used.

Unfortunately, these traditional gift cards have many accompanying disadvantages. Users can easily damage a gift card, thereby rendering the gift card worthless if users were unable to prove the validity of the gift card. Further, it is easy to lose or misplace a gift card, as users do not always remember to bring gift cards before going to a store. With the growing use and popularity of internet services, gift cards have been adapted to work as digital items, often able to be used with smartphones or similar wireless devices to address the disadvantages of physical gift cards. However, digital gift cards can also have various disadvantages. While users are able to obtain a desired gift card from their preferred business, the processes of purchasing, managing, and gifting can be oftentimes cumbersome. Many businesses which offer digital gift cards allow for some level of management after the purchase of the gift cards. However, the control given to the owner is often limited to balance checking and transferals or purchasing of additional gift cards. Further, if the business does not allow for partial transfer of balance from an already purchased gift card as a gift to another user, the original users have to obtain additional gift cards to gift. What is needed is a new service which overcomes the disadvantages of currently available digital gift card services is necessary.

The present invention addresses these issues. An objective of the present invention is to provide an improved digital gift card service which overcomes the disadvantages of the currently available services. The present invention makes it simple for businesses to create their own gift cards and to encourage users to purchase the gift cards through an application provided by the present invention. The present invention further allows users to discover new businesses located nearby as well as business which match the users' interests. The present invention further allows users to share gift cards through the application, which in turn promotes gift card sharing into a social activity.

### BRIEF DESCRIPTION OF THE DRAWINGS

FIG. 1 is a flowchart illustrating the system of the present invention.

FIG. 2 is a flowchart illustrating the overall process for the method of the present invention.

FIG. 3 is a flowchart illustrating the subprocess of filtering through business accounts.

FIG. 4 is a flowchart illustrating the subprocess of determining business locations proximal to the user.

FIG. 5 is a flowchart illustrating the subprocess of adding promotional incentives to virtual gift card values.

FIG. 6 is a flowchart illustrating the subprocess of inserting preferred virtual gift card values.

FIG. 7 is a flowchart illustrating the subprocess of spending a virtual gift card with a visual code.

FIG. 8 is a flowchart illustrating the subprocess of spending a virtual gift card with a contactless payment signal.

FIG. 9 is a flowchart illustrating the subprocess of sending a virtual gift card to another user.

FIG. 10 is a flowchart illustrating the subprocess of sending a message to another user along with a virtual gift card.

FIG. 11 is a flowchart illustrating the subprocess of purchasing multiple virtual gift cards.

### DETAILED DESCRIPTION OF THE INVENTION

All illustrations of the drawings are for the purpose of describing selected versions of the present invention and are not intended to limit the scope of the present invention.

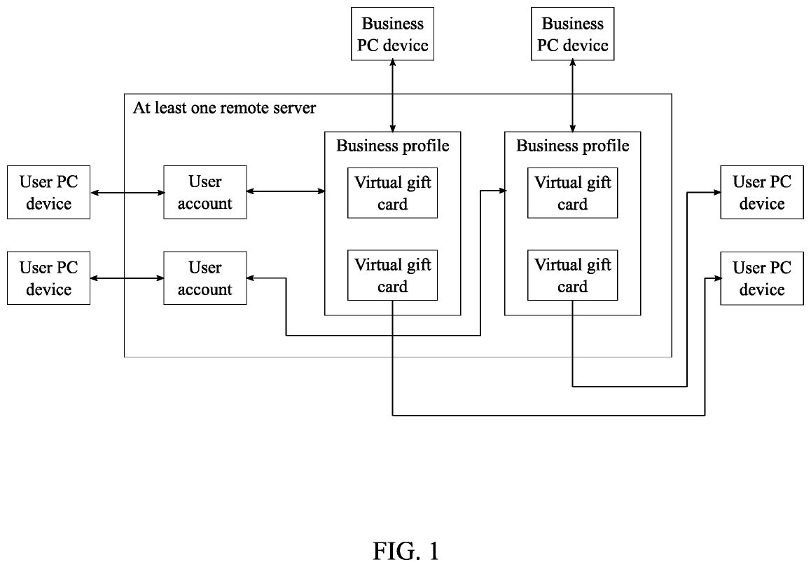

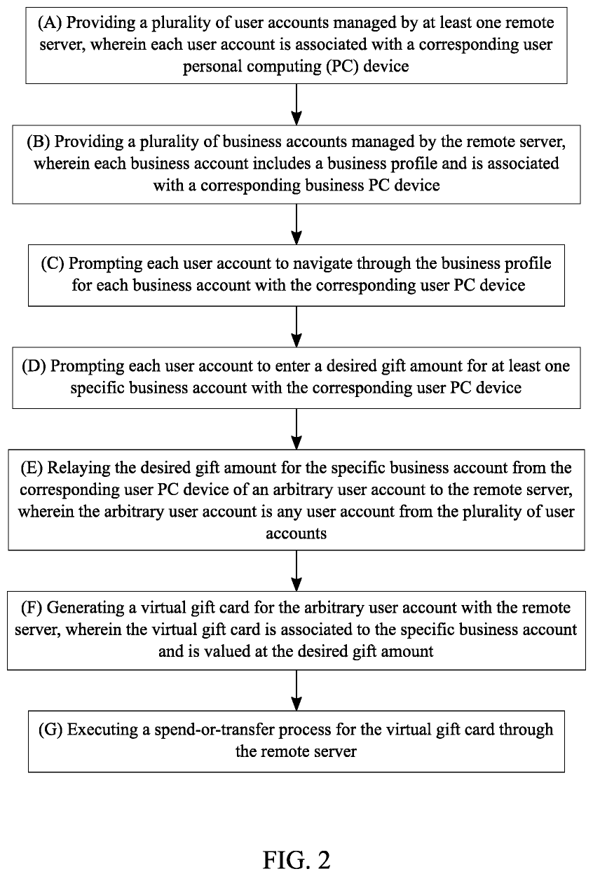

The present invention is a method of managing pre-dedicated funds that allows the user to purchase, distribute, and manage gift cards. The present invention allows companies to provide discounts and promotions to gift card users, as represented in FIG. 1. The system of the present invention includes a plurality of user accounts managed by at least one remote server, wherein each user account is associated with a corresponding user personal computer (PC) device (Step A), as represented in FIG. 2. The plurality of user accounts is a mechanism by which each user of the present invention may interact with each other through the at least one remote server in order to manage gift cards. The at least one remote server is a series of programmable databases which accept wireless electronic inputs and return appropriate electronic outputs. The corresponding PC device is any computer, laptop, smartphone, or other such internet-enabled device that allows the plurality of users to connect to the at least one remote server. This arrangement enables each user to interact with the at least one remote server using the corresponding PC device.

The present invention follows an overall process in order to provide a gift card-based storefront for businesses and users. For the overall process, as represented in FIG. 2, the method of the present invention includes a plurality of business accounts managed by the remote server, wherein each business account includes a business profile and is associated with a corresponding business PC device (Step B). The plurality of business accounts is a mechanism by which each business owner user of the present invention may interact with each other business account and user account through the at least one remote server in order to manage gift cards. The business profile relates to a display representing each business account that can be accessed by each user account. Thus, each user account can access the business profile of each business account. Each user account is prompted to navigate through the business profile for each business account with the corresponding user PC device (Step C). Thus, the user account may interact with the business profile to identify gift cards and deals. Each user account is prompted to enter a desired gift amount for at least one specific business account with the corresponding user PC device (Step D). In this arrangement, the user can decide the amount desired for each gift card.

Following receipt of the desired gift amount, the desired gift amount for the specific business account is relayed from the corresponding user PC device of an arbitrary user account to the remote server, wherein the arbitrary user account is any user account from the plurality of user accounts (Step E). Thus, the remote server is provided with the necessary information to make appropriate subsequent action by providing an appropriately valued gift card. A virtual gift card is then generated for the arbitrary user account with the remote server, wherein the virtual gift card is associated to the specific business account and is valued at the desired gift amount (Step F). The virtual gift card contains funds that are spendable at the associated business profile. Finally, a spend-or-transfer process is executed for the virtual gift card through the remote server (Step G). Thus, the arbitrary user account has the ability to gift the virtual gift card to another user account of the plurality of user accounts, or to credit a purchase up to the amount on the virtual gift card to the virtual gift card.

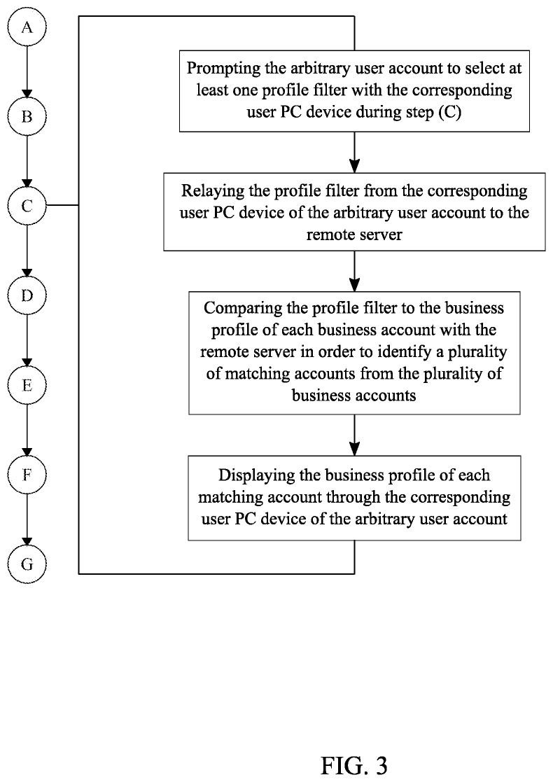

A user account may desire to navigate through the plurality of business accounts by sorting through based on a variety of different criteria, such as location or item types. To address this need, the arbitrary user account is prompted to select at least one profile filter with the corresponding user PC device during Step C, as represented in FIG. 3. The at least one profile filter may be any of item type, location, business name, or a variety of other search criteria. The profile filter is relayed from the corresponding user PC device of the arbitrary user account to the remote server. Therefore, the remote server is equipped to execute commands with respect to the relevant business profile of the plurality of business profiles. The profile filter is compared to the business profile of each business account with the remote server in order to identify a plurality of matching accounts from the plurality of business accounts. Thus, several options are determined from a list of the business profiles and provided to the arbitrary user account. Finally, the business profile of each matching account is displayed through the corresponding user PC device of the arbitrary user account. Such an arrangement provides the user with the appropriate information necessary to make a decision about where to purchase a virtual gift card.

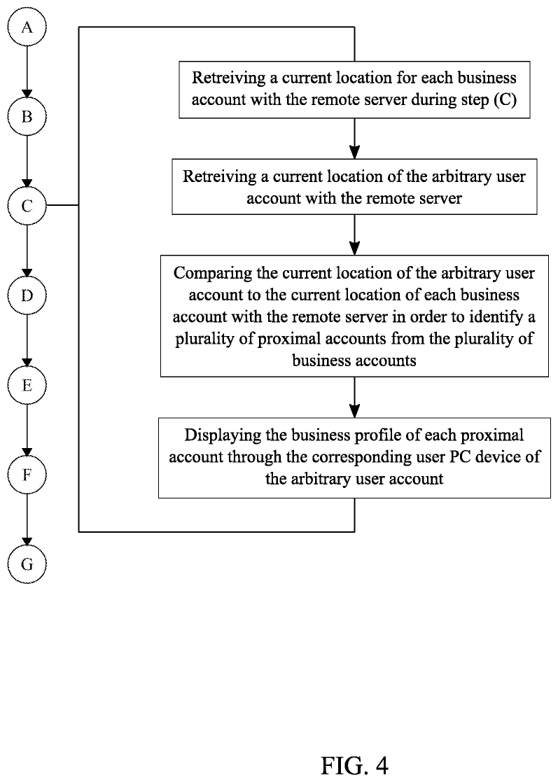

In order to utilize location as a search criterium for the plurality of user accounts, the present invention must account for business locations and the user's location. To this end, a current location for each business account is retrieved with the remote server during Step C, as represented in FIG. 4. This enables the remote server to utilize the current location for each business account to provide information for the arbitrary user account. A current location of the arbitrary user account is also retrieved with the remote server. In this way, the remote server can access both the current location of the arbitrary user account and the current location for each business account. Next, the current location of the arbitrary user account is compared to the current location of each business account with the remote server in order to identify a plurality of proximal accounts from the plurality of business accounts. The remote server therefore can determine convenience for a user to approach a physical store location for in-person virtual gift card usage, or for general user convenience. Finally, the business profile of each proximal account is displayed through the corresponding user PC device of the arbitrary user account. Thus, the arbitrary user account is provided with a set of the nearest relevant businesses. In an exemplary embodiment, the business accounts are listed according to proximity to the arbitrary user account.

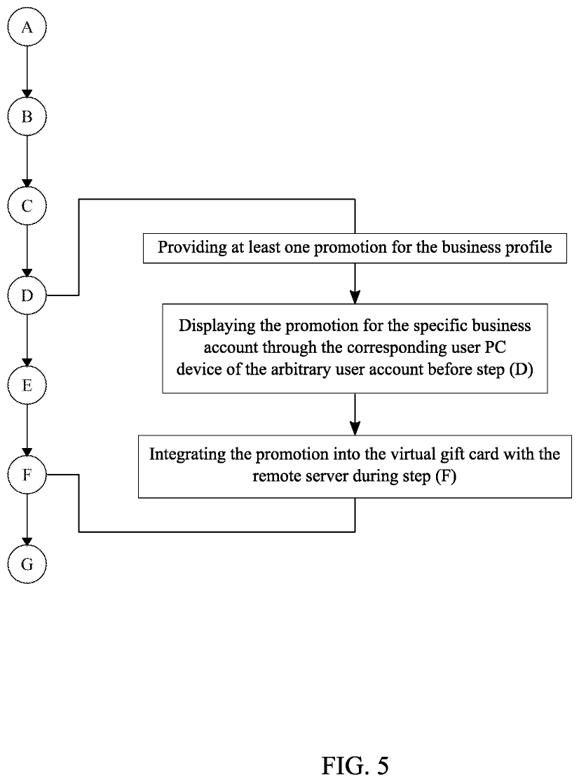

Various businesses may desire to attract customers to purchase their virtual gift cards by providing special deals to customers who use virtual gift cards. In order to accommodate for this, at least one promotion is provided for the business profile, as represented in FIG. 5. The at least one promotion relates to one or more discounts or deals on one or more items being sold by the business profile. The promotion for the specific business account is displayed through the corresponding user PC device of the arbitrary user account during Step D. Thus, the specific user account is able to identify deals and promotions that can save the user money. The promotion is then integrated into the virtual gift card with the remote server during Step F. In this way, the user can store limited time offers or other promotions upon a specific gift card for convenient use.

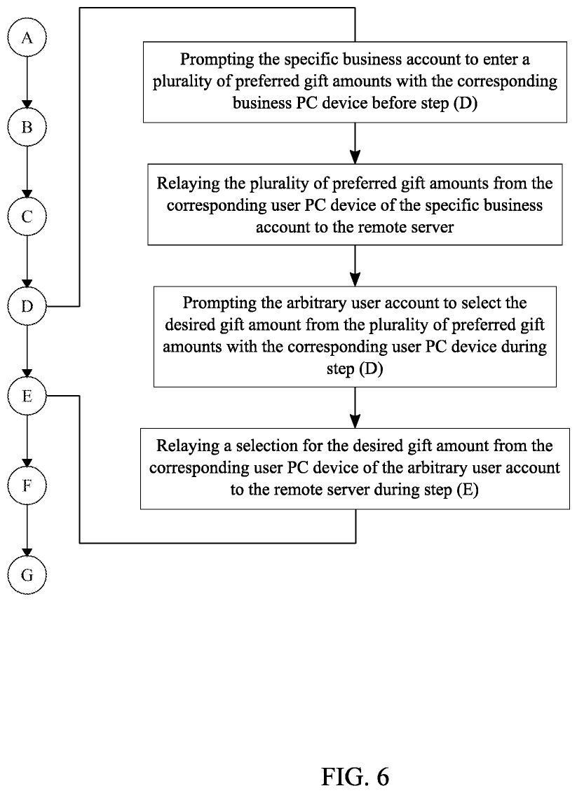

Gift cards are valuable in part because it is difficult to spend exactly the amount stored upon the gift card, meaning the user will often either not spend the full value or will have to spend additional money to complete the purchase, with either case being advantageous to the business owner. To enable the business accounts to leverage this strategy, the specific business account is prompted to enter a plurality of preferred gift amounts with the corresponding business PC device during Step D, as represented in FIG. 6. Thus, the business account can predetermine values available for the plurality of user accounts to purchase. The plurality of preferred gift amounts is relayed from the corresponding user PC device of the specific business account to the remote server. This arrangement allows the remote server to store desirable virtual gift card values. Next, the arbitrary user account is prompted to select the desired gift amount from the plurality of preferred gift amounts with the corresponding user PC device during Step D. In this way, the desired gift amount is provided to the arbitrary user account for purchasing. Finally, a selection for the desired gift amount is relayed from the corresponding user PC device of the arbitrary user account to the remote server during Step E. Thus, the desired gift amount is chosen and stored ultimately within a virtual gift card.

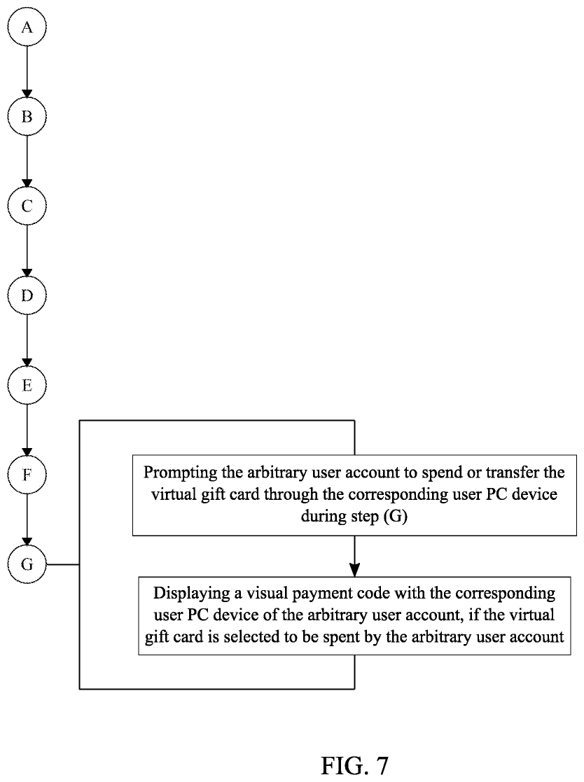

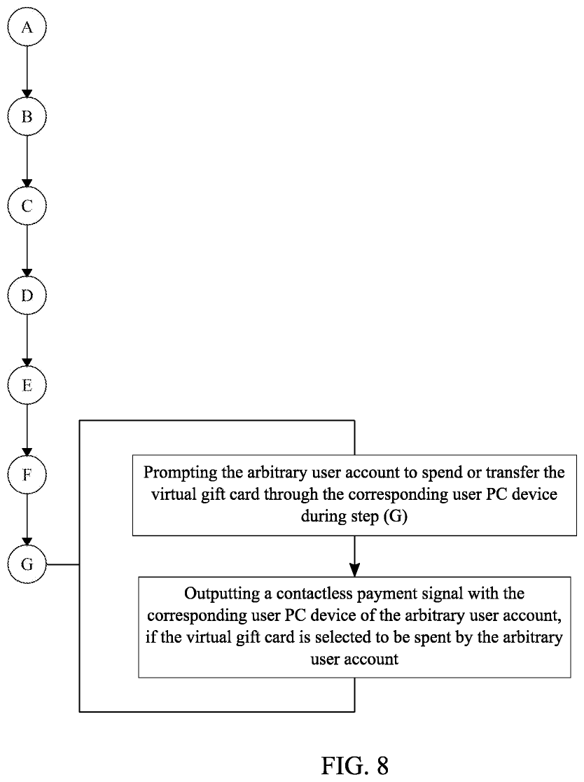

A user account may wish to use the corresponding user PC device to make purchases from a virtual gift card. To accommodate for this desire, the arbitrary user account is prompted to spend or transfer the virtual gift card through the corresponding user PC device during Step G, as represented in FIG. 7. In this way, the user can inform the remote server as to when it is time to utilize the virtual gift card. Then, a visual payment code is displayed with the corresponding user PC device of the arbitrary user account, if the virtual gift card is selected to be spent by the arbitrary user account. The visual payment code may be a quick response (QR), barcode, or other patterned code that enables secure transmission of financial information between parties. Similarly, a user may wish to transmit their virtual gift card information using a non-visual mechanism. To this end, the arbitrary user account is prompted to spend or transfer the virtual gift card through the corresponding user PC device during Step G, as represented in FIG. 8. In this way, the user can inform the remote server as to when it is time to utilize the virtual gift card. Then, a contactless payment signal is outputted with the corresponding user PC device of the arbitrary user account, if the virtual gift card is selected to be spent by the arbitrary user account. The contactless payment signal may be any radio-frequency identification (RFID) type signal, or a variety of alternative codes that enables secure transmission of financial information between parties. Thus, the present invention allows users to spend their virtual gift cards from the corresponding user PC device.

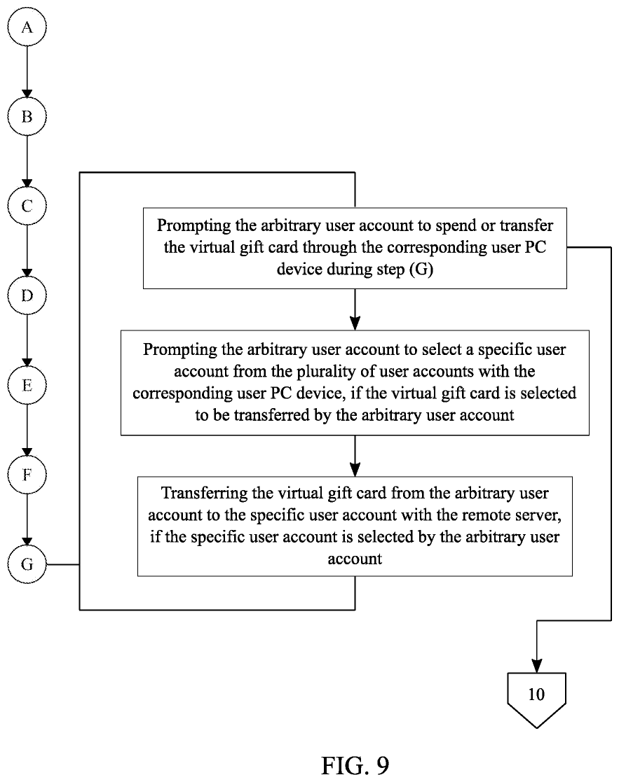

A user of the present invention may desire to send a virtual gift card to a friend or acquaintance as a gift. In order to allow for such a transaction, the arbitrary user account is prompted to spend or transfer the virtual gift card through the corresponding user PC device during Step G, as represented in FIG. 9. Thus, the arbitrary user account determines when it is appropriate to utilize the virtual gift card in various ways. The arbitrary user account is prompted to select a specific user account from the plurality of user accounts with the corresponding user PC device, if the virtual gift card is selected to be transferred by the arbitrary user account. Thus, the arbitrary user account has the ability to interact with other users for facilitated exchange of virtual gift cards. Finally, the virtual gift card is transferred from the arbitrary user account to the specific user account with the remote server, if the specific user account is selected by the arbitrary user account. In this way, the present invention provides a virtual gift card exchanging economy that avoids the inconveniences associated with physical gift cards. In an exemplary embodiment, a specific age of the arbitrary user account is collected. The specific age is compared by the remote server to an exchange cutoff age. If the specific age is found by the remote server to be less than the exchange cutoff age, the arbitrary user account is prevented from purchasing virtual gift cards. Thus, children and minors cannot purchase their virtual gift cards but can still receive, spend, and transfer virtual gift cards. An associated custodial user account may selectively toggle virtual gift card purchasing ability for the user account of the minor.

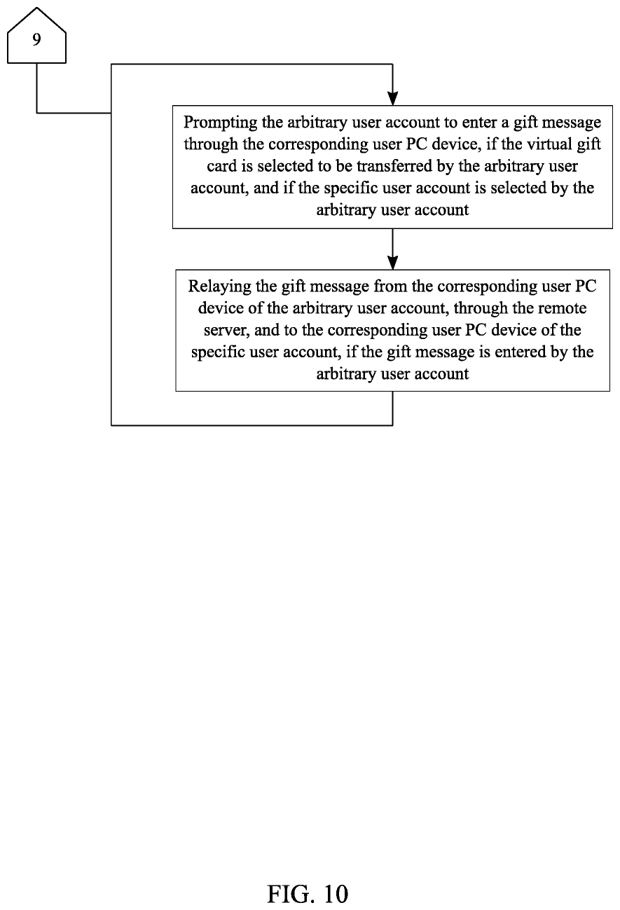

In conjunction with the transferal of virtual gift cards, the user may desire to send an accompanying message. To provide this capability, the arbitrary user account is prompted to enter a gift message through the corresponding user PC device, if the virtual gift card is selected to be transferred by the arbitrary user account, and if the specific user account is selected by the arbitrary user account, as represented in FIG. 10. The gift message may contain any of a variety of alphanumeric characters, as well as a variety of symbols and images. Next, the gift message is relayed from the corresponding user PC device of the arbitrary user account, through the remote server, and to the corresponding user PC device of the specific user account, if the gift message is entered by the arbitrary user account. Thus, the specific user account may receive an accompanying message composed by the arbitrary user account.

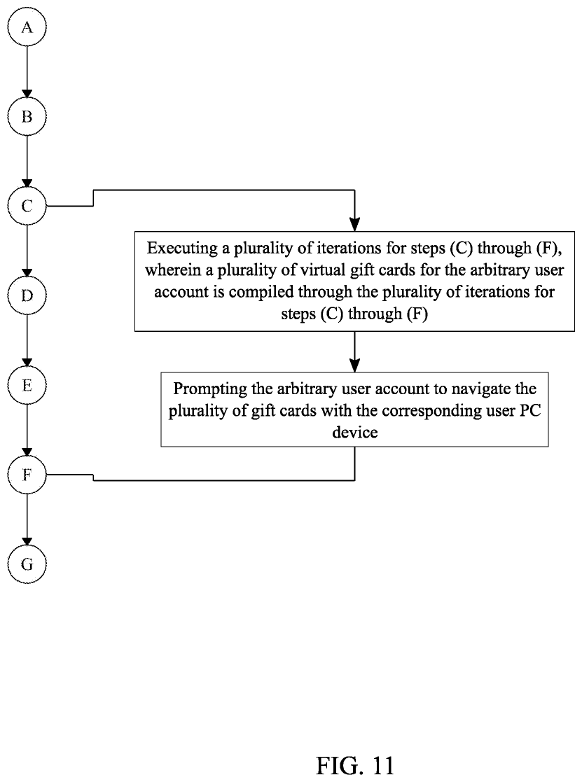

A user may wish to make several purchases of virtual gift cards at once. To this end, a plurality of iterations is executed for Steps C through F, wherein a plurality of virtual gift cards for the arbitrary user account is compiled through the plurality of iterations for Steps C through F, as represented in FIG. 11. In doing so, the arbitrary user account will accumulate a number of virtual gift cards for subsequent management. The arbitrary user account is prompted to navigate the plurality of gift cards with the corresponding user PC device. Thus, the user is able to select a relevant virtual gift card for use or distribution. Although the invention has been explained in relation to its preferred embodiment, it is to be understood that many other possible modifications and variations can be made without departing from the spirit and scope of the invention as hereinafter claimed.

What is claimed is:

1. A method of managing pre-dedicated funds, the method comprises the steps of:
(A) providing a plurality of user accounts managed by at least one remote server, wherein each user account is associated with a corresponding user personal computing (PC) device;
(B) providing a plurality of business accounts managed by the remote server, wherein each business account includes a business profile and is associated with a corresponding business PC device;
(C) prompting each user account to navigate through the business profile for each business account with the corresponding user PC device;
(D) prompting each user account to enter a desired gift amount for at least one specific business account with the corresponding user PC device;
(E) relaying the desired gift amount for the specific business account from the corresponding user PC device of an arbitrary user account to the remote server, wherein the arbitrary user account is any user account from the plurality of user accounts;
(F) generating a virtual gift card for the arbitrary user account with the remote server, wherein the virtual gift card is associated to the specific business account and is valued at the desired gift amount; and
(G) executing a spend-or-transfer process for the virtual gift card through the remote server.

2. The method of managing pre-dedicated funds, the method as claimed in claim 1 comprises the steps of:
prompting the arbitrary user account to select at least one profile filter with the corresponding user PC device during step (C);
relaying the profile filter from the corresponding user PC device of the arbitrary user account to the remote server;
comparing the profile filter to the business profile of each business account with the remote server in order to identify a plurality of matching accounts from the plurality of business accounts; and
displaying the business profile of each matching account through the corresponding user PC device of the arbitrary user account.

3. The method of managing pre-dedicated funds, the method as claimed in claim 1 comprises the steps of:
retrieving a current location for each business account with the remote server during step (C);
retrieving a current location of the arbitrary user account with the remote server;
comparing the current location of the arbitrary user account to the current location of each business account with the remote server in order to identify a plurality of proximal accounts from the plurality of business accounts; and
displaying the business profile of each proximal account through the corresponding user PC device of the arbitrary user account.

4. The method of managing pre-dedicated funds, the method as claimed in claim 1 comprises the steps of:
providing at least one promotion for the business profile;
displaying the promotion for the specific business account through the corresponding user PC device of the arbitrary user account before step (D); and
integrating the promotion into the virtual gift card with the remote server during step (F).

5. The method of managing pre-dedicated funds, the method as claimed in claim 1 comprises the steps of:
prompting the specific business account to enter a plurality of preferred gift amounts with the corresponding business PC device before step (D);
relaying the plurality of preferred gift amounts from the corresponding user PC device of the specific business account to the remote server;
prompting the arbitrary user account to select the desired gift amount from the plurality of preferred gift amounts with the corresponding user PC device during step (D); and
relaying a selection for the desired gift amount from the corresponding user PC device of the arbitrary user account to the remote server during step (E).

6. The method of managing pre-dedicated funds, the method as claimed in claim 1 comprises the steps of:
prompting the arbitrary user account to spend or transfer the virtual gift card through the corresponding user PC device during step (G); and
displaying a visual payment code with the corresponding user PC device of the arbitrary user account, if the virtual gift card is selected to be spent by the arbitrary user account.

7. The method of managing pre-dedicated funds, the method as claimed in claim 1 comprises the steps of:
prompting the arbitrary user account to spend or transfer the virtual gift card through the corresponding user PC device during step (G); and
outputting a contactless payment signal with the corresponding user PC device of the arbitrary user account, if the virtual gift card is selected to be spent by the arbitrary user account.

8. The method of managing pre-dedicated funds, the method as claimed in claim 1 comprises the steps of:
prompting the arbitrary user account to spend or transfer the virtual gift card through the corresponding user PC device during step (G);
prompting the arbitrary user account to select a specific user account from the plurality of user accounts with the corresponding user PC device, if the virtual gift card is selected to be transferred by the arbitrary user account; and
transferring the virtual gift card from the arbitrary user account to the specific user account with the remote server, if the specific user account is selected by the arbitrary user account.

9. The method of managing pre-dedicated funds, the method as claimed in claim 8 comprises the steps of:
prompting the arbitrary user account to enter a gift message through the corresponding user PC device, if the virtual gift card is selected to be transferred by the arbitrary user account, and if the specific user account is selected by the arbitrary user account; and
relaying the gift message from the corresponding user PC device of the arbitrary user account, through the remote server, and to the corresponding user PC device of the specific user account, if the gift message is entered by the arbitrary user account.

10. The method of managing pre-dedicated funds, the method as claimed in claim 1 comprises the steps of:
executing a plurality of iterations for steps (C) through (F), wherein a plurality of virtual gift cards for the arbitrary user account is compiled through the plurality of iterations for steps (C) through (F); and
prompting the arbitrary user account to navigate the plurality of gift cards with the corresponding user PC device.
